(19) United States
(12) Patent Application Publication
(10) Pub. No.: US 2020/0410317 A1
(43) Pub. Date: Dec. 31, 2020

(54) SYSTEM AND METHOD FOR ADJUSTING PRESENTATION FEATURES OF A SOCIAL ROBOT

(71) Applicant: Intuition Robotics, Ltd., Ramat-Gan (IL)

(72) Inventors: Shay ZWEIG, Harel (IL); Roy AMIR, Mikhmoret (IL); Itai MENDELSOHN, Tel Aviv-Yafo (IL); Dor SKULER, Oranit (IL)

(73) Assignee: Intuition Robotics, Ltd., Ramat-Gan (IL)

(21) Appl. No.: 16/913,742

(22) Filed: Jun. 26, 2020

Related U.S. Application Data
(60) Provisional application No. 62/867,324, filed on Jun. 27, 2019.

(51) Int. Cl. G06N 3/00; G06N 20/00

(52) U.S. Cl. CPC G06N 3/006; G06N 20/00

(57) ABSTRACT

A system and method for real-time customization of presentation features of a social robot. A method includes collecting a first dataset regarding a knowledge level of a user of the social robot with respect to at least one feature of the social robot; collecting a second dataset, wherein the second dataset data is collected from at least an environment of the social robot; determining, based on the first dataset and the second dataset, at least one presentation feature from a plurality of presentation features; selecting a first presentation feature of the at least one presentation feature; customizing the selected first presentation feature based on at least the first dataset; and presenting in real-time the customized presentation feature, wherein the presentation is performed using at least one electronic component of the social robot.

### CROSS REFERENCE TO RELATED APPLICATIONS

This application claims the benefit of U.S. provisional application 62/867,324 filed on Jun. 27, 2019, the contents of which are hereby incorporated by reference.

### TECHNICAL FIELD

The disclosure generally relates to electronic devices and, more specifically, to a system and method for real-time customization of presentation features of an electronic social robot.

### BACKGROUND

As technology develops, electronic devices include many functionalities designed to assist users by providing greater numbers of, and greater utility from, included features. For example, some electronic devices, such as robots, have the ability to play music based on a user's voice command. Further, some features are designed to control other electronic devices that are located within the users' homes, as well as other, similar, functions.

Some solutions introduced by the prior art depict systems by which the identity of the user is determined and, based on the known identity, the system determines which features are flagged for training based on a user profile. When the user activates one of the flagged features, the system provides an audiovisual description which includes descriptions of the feature, a use case of the feature, limitations of the feature and, in some cases, a demonstration of alerts generated by the feature.

One disadvantage of solutions introduced in the prior art is that such solutions do not consider real-time circumstances in which the user may be confused, stressed, or inexperienced in operating certain features.

Therefore, it would be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for real-time customization of presentation features of a social robot. The method comprises: collecting a first dataset regarding a knowledge level of a user of the social robot with respect to at least one feature of the social robot; collecting a second dataset, wherein the second dataset data is collected from at least an environment of the social robot; determining, based on the first dataset and the second dataset, at least one presentation feature from a plurality of presentation features; selecting a first presentation feature of the at least one presentation feature; customizing the selected first presentation feature based on at least the first dataset; and presenting in real-time the customized presentation feature, wherein the presentation is performed using at least one electronic component of the social robot.

Certain embodiments disclosed herein also include a non-transitory computer readable medium having stored thereon instructions for causing a processing circuitry to execute a process, the process comprising: collecting a first dataset regarding a knowledge level of a user of the social robot with respect to at least one feature of the social robot; collecting a second dataset, wherein the second dataset data is collected from at least an environment of the social robot; determining, based on the first dataset and the second dataset, at least one presentation feature from a plurality of presentation features; selecting a first presentation feature of the at least one presentation feature; customizing the selected first presentation feature based on at least the first dataset; and presenting in real-time the customized presentation feature, wherein the presentation is performed using at least one electronic component of the social robot.

Certain embodiments disclosed herein also include a controller for real-time customization of presentation features of a social robot, comprising: a processing circuitry; and a memory, the memory containing instructions that, when executed by the processing circuitry, configure the controller to: collect a first dataset regarding a knowledge level of a user of the social robot with respect to at least one feature of the social robot; collect a second dataset, wherein the second dataset data is collected from at least an environment of the social robot; determine, based on the first dataset and the second dataset, at least one presentation feature from a plurality of presentation features; select a first presentation feature of the at least one presentation feature; customize the selected first presentation feature based on at least the first dataset; and present in real-time the customized presentation feature, wherein the presentation is performed using at least one electronic component of the social robot.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various embodiments for customizing presentation features of a social robot.

FIG. 2 is a block diagram depicting a controller configured to perform the disclosed embodiments.

FIG. 3 is a flowchart depicting a method for real-time customization of presentation features of a social robot, according to an embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality. In the drawings, like numerals refer to like parts through several views.

According to some example embodiments, techniques for adjusting presentation features of a social robot are disclosed. A first set of data indicating the knowledge level of a user, who is a target of an interaction with the social robot, is collected with respect to all available features of the social robot. A second set of data is collected by the social robot. The second set of data may be collected from the device environment, using one or more sensors, from the internet, social media, the user's calendar, from other, like, sources, or from any combination thereof. Based on the first and the second set of data, a first presentation feature is selected and subsequently customized based on at least the first set of data. The customized presentation feature is then presented using at least one electronic component of the social robot.

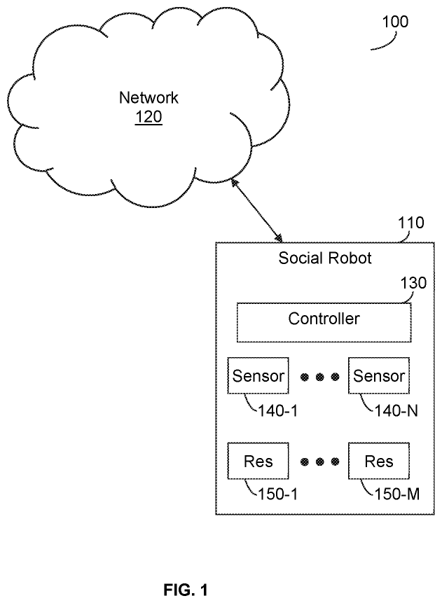

FIG. 1 is an example network diagram 100 utilized to describe the various embodiments for customizing presentation features of a social robot 110. The social robot 110 includes a controller (agent) 130 configured to perform the various embodiments for customizing presentation features of the social robot 110.

The social robot 110 is connected to a network 120. The network 120 may be, but is not limited to, a local area network (LAN), a wide area network (WAN), a metro area network (MAN), the internet, a wireless, cellular, or wired network, other, like, networks, or any combination thereof. A user of the system depicted in the diagram 100 may access the social robot 110 directly, such as via a voice command or another input into a device connected directly or indirectly to the network 120. The social robot 110 allows an interaction with a user, typically an elderly person. Example implementation of a social robot is discussed in U.S. patent application Ser. No. 16/507,599 assigned to the common assignee and hereby incorporated by reference.

The social robot 110 and, thus, the controller 130, can operate with a plurality of sensors 140, marked 140-1 through 140-N, where N is a natural number, (hereinafter, “sensor” 140 or “sensors” 140), which allow direct or indirect input into the social robot 110. Some sensors 140 may be integrated in the social robot 110, while some may be connected to the social robot 110 over the network 120. For example, but not by way of limitation, communication may occur by using a microphone as a sensor 140, such as, for example, sensor 140-1. Indirect communication may occur, by way of example but not by way of limitation, through an application on a mobile phone (not shown) communicatively connected to a sensor 140 such as, for example, sensor 140-2 (not shown), where the social robot 110, by means of the network 120, is additionally connected to the internet.

The social robot 110 may be further communicated with a plurality of resources 150, marked 150-1 through 150-M, where M is a natural number (hereinafter, “resource” 150 or “resources” 150). The resources 150 may include, but are not limited to, display units, audio speakers, lighting systems, other, like, resources, and any combination thereof. In an embodiment, the resources 150 may encompass sensors 140 as well, or vice versa. That is, a single element may have the capabilities of both a sensor 140 and a resource 150 in a single unit. In an embodiment, the resources 150 may be an integral part of the social robot 110 (not shown), such that the electronic agent system according to the embodiment described in the diagram 100 may be configured to use the resource of the social robot 110 to communicate with the user.

As will be discussed in detail below, the controller 130 is configured to customize in real-time presentation features of a social robot. To this end, the controller 130 is configured to collect a first dataset regarding a knowledge level of a user of the social robot with respect to at least one feature of the social robot 110, to collect a second set of data from the sensors 140, to determine, based on the first set of data and the second set of data, at least one presentation feature from a plurality of presentation features, to select a first presentation feature of the at least one presentation feature, to customize the selected first presentation feature based on at least the first set of data, and to present, in real-time, the customized presentation feature. The presentation is performed by modifying the presentation.

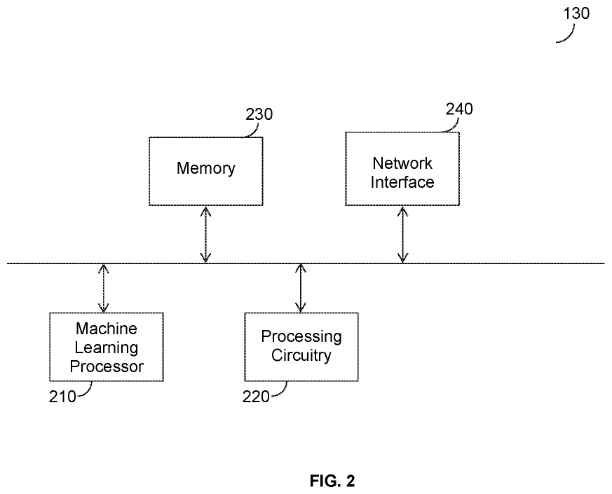

FIG. 2 shows an example block diagram of the controller 130 according to an embodiment. The controller 130 includes a machine learning processor (MLP) 210, a processing circuitry 220, a memory 230, and network interface 240.

The MLP 210 is configured to progressively improve the performance of the social robot for providing a customized presentation feature of the social robot to the user based, for example, on the data collected by the sensors 140, as further described hereinbelow. The MLP 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information, and may further comprise firmware components, software components, or both firmware components and software components, residing in memory.

In an embodiment, the MLP 210 is configured to process, train, and apply machine learning models as discussed herein. Training and utilizing such models is performed, in part, based on data received from the sensors 140 with respect to the human-machine interaction.

A processing circuitry 220 typically operates by executing instructions stored in a memory, such as the memory 230 described below, executing the various processes and functions which the controller 130 is configured to perform. In an embodiment, the processing circuitry 220 may be realized as one or more hardware logic components and circuits. For example, and without limitation, illustrative types of hardware logic components that can be used include FPGAs, ASICs, ASSPs, SOCs, general-purpose microprocessors, microcontrollers, DSPs, and the like, or any other hardware logic components that can perform calculations or other manipulations of information, and may further comprise firmware components, software components, or both, residing in memory.

Specifically, the models and algorithms used to adapt the MLP 210 are tuned to analyze data that is collected from, for example, one or more sensors, such as the sensors 140, from the internet, social media, a user's calendar, other, like, sources, or any combination thereof, as further discussed herein. In an embodiment, the MLP 210 and the processing circuitry 220 are integrated into a single unit for practical implementation and design considerations apparent to those of ordinary skill in the art.

It should be noted that the output of the MLP 210 may be used by the processing circuitry 220 to execute at least a portion of the processes that are described hereinbelow. The system may be, as discussed herein, integrated into other social robots for the purpose of presenting customized presentation feature as described herein in greater detail. In an embodiment, the MLP 210 may be further configured to select a presentation feature that is appropriate based on the identified circumstances, such as, as examples and without limitation, user data, environment data, data collected from the user's calendar, data collected from the internet, other, like, data, and any combination thereof.

A memory 230 may contain therein instructions that, when executed by the processing circuitry 220, cause it to execute actions as further described herein. The memory 230 may further store therein information, such as data associated with predetermined plans that may be executed by one or more resources, such as the resources 150, in order to communicate with a user, present a particular feature, and achieve other, like, aims.

In one embodiment, the memory 230 may store a variety of predetermined presentation features to be executed, using the resources 150, as further discussed hereinbelow. According to another embodiment, the memory 230 may include historical data associated with the user of a specific social robot. The historical data may be retrieved from a database and used to determine, for example, the most effective way of using the resources 150 in consideration of a specific identified user.

For example, when a user is identified by the social robot, such as a social robot described by reference herein, as a new user, and the robot identifies that the new user has just received an email, the social robot, i.e., the controller 130, may be configured to suggest that the new user use a “read out loud” feature, where such a feature reads out loud the email for the user, using an elaborated presentation of the feature. According to the same example, after several times in which the user uses this specific feature, the controller 130 may use a different, and less elaborate presentation, if any, when an email is received by the social robot.

As further described in detail below, the purpose of this disclosure is to determine whether one or more features of the social robot, such as a robot, a vehicle, a smart appliance, and the like, may assist the user in operating the social robot based on the user's knowledge level of the available features of the social robot and based on data that is collected with respect to at least the environment of the social robot. Upon selecting a presentation feature, the controller 130 customizes, in real-time or near-real-time, the selected presentation feature based on at least the user's knowledge level regarding the available features of the social robot and presents, in real-time, the customized presentation feature. A customized presentation of a feature of an social robot, which is appropriate with respect to the knowledge level of the user, with respect to the available features of the social robot, and the data that is collected from the environment of the social robot, allows for the automatic suggestion, in real-time, of important and useful features of which the user was not aware, and may assist the user in certain scenarios.

In an embodiment, the controller 130 is configured to collect a first set of data regarding a knowledge level of a user of a social robot with respect to at least one feature of the social robot. A user of the social robot may be a person who is a target of an interaction with the social robot, an occupant, one of the aforementioned users' family members, a passenger in a vehicle, and the like. Features of the social robot may include, for example, reading out loud received messages, displaying images and videos in which the user was tagged, controlling other social robots in the user's home, such as the air conditioner, parking-assist features in vehicles, performing a search online based on a voice command, and the like.

The knowledge level of the user with respect to one or more features of the social robot indicates whether the user is familiar with a specific feature, the user's level of familiarity, and the like, as well as any combination thereof. In an embodiment, the first set of data may be collected by, for example, the sensors 140, and may include sensor data that is associated with the user. For example, the user may be identified as a new and an elderly user using the collected sensor data. According to a further embodiment, the first set of data may be inputted by the user. For example, the controller 130 may emit a question, such as by using the speakers and the display unit of the social robot, asking a new user whether he or she is familiar with a specific feature. Thus, the user's answer may be used in determining the user's knowledge level with respect to the social robot features.

In an embodiment, the controller 130 is further configured to collect a second set of data. The second set of data is collected from at least an environment of the social robot using, for example, one or more sensors, such as the sensors 140. The environment of the social robot may include the number of people in the room in which the social robot is located, the interactions between the people, the temperature within the room in which the social robot is located, and the like, as well as any combination thereof. The second set of data may indicate that, for example, the user sits at his or her home with three other elders, that all four people are watching television, and that all four seem to be amused.

As another example, the second set of data may indicate that the user is alone at home, that the current season is winter, and that the temperature within the user's house is fifty-nine degrees Fahrenheit. In an embodiment, the second set of data may also be collected from, for example, the internet, one or more databases, the user's calendar, social media, and the like, as well as any combination thereof. Thus, the second set of data that is collected from, for example, the user's calendar may indicate that the user's daughter's birthday is the next day.

In an embodiment, the controller 130 may determine, based on the first set of data and the second set of data, at least one presentation feature, of a plurality of feature presentations. In an embodiment, the determination of the at least one presentation feature may be achieved by applying one or more machine learning algorithms, using the MLP 210, to at least the second set of data. By applying the one or more machine learning algorithms, the controller 130 is configured to determine the current scenario or circumstances. Thus, by analyzing the first set of data with an output of the one or more machine learning algorithms, one or more presentation features that are appropriate with respect to the user's knowledge level and the circumstances, are determined.

According to a further embodiment, the determination may be achieved based on analysis of the first set of data and the second set of data by at least a predetermined rule. Such predetermined rules may indicate an appropriate presentation feature based on a current identified scenario, which may be determined based on the collected first set and second set of data. According to another embodiment, the determination may be achieved using the aforementioned one or more machine learning algorithms, the one or more predetermined rules, and the like, as well as any combination thereof.

It should be noted that the plurality of presentation features may include several different ways to present the same feature, as well as several ways to present several different features. For example, for the purpose of presenting a certain feature of the social robot to the user, a first presentation may use only vocal notifications, a second feature may use both vocal and visual notifications, a third presentation may use a long and elaborate explanation, a fourth presentation may use a short explanation, and the like.

In an embodiment, the controller 130 is configured to select a first presentation feature from the at least one presentation feature. The selection may be achieved based on the collected first set of data and the second set of data. Specifically, the selection may be achieved based on the result of the analysis of the first set of data and the second set of data, as further described hereinabove. The selected first feature may include displaying a twenty-second video on the social robot display, for explaining to a new user a certain feature with which the user is not familiar. In an embodiment, the controller 130 may identify that the user is sitting in his or her home not doing anything important and, therefore, the controller 130 may present a feature with which the user is not familiar, using a selected presentation feature that is customized, as further discussed hereinbelow, based on the current identified scenario and the user's knowledge level regarding the social robot features.

In an embodiment, the controller 130 is configured to customize, such as in real-time, the selected first presentation feature, based on at least the first set of data. In an embodiment, the customization is achieved based on the second set of data as well. The customization may include selecting the elaboration level of the selected first feature, selecting the tone, the volume, or both, of a vocal explanation, selecting whether to use a visual element to present the selected feature, a vocal notification, and the like, as well as any combination thereof.

For example, the controller 130 is configured to identify that the user is not familiar with a feature that enables the user to control the air conditioner using a voice command that is received at, and executed by, the social robot, that the user is in bed, that the time after 10:30 PM, and that the room is very cold. According to the same example, and considering the circumstances, the controller 130 may customize the specific presentation feature such that an elaborate explanation, which includes only a vocal element, is emitted in a very pleasant and quiet tone.

In an embodiment, the controller 130 may present, in real-time, the customized presentation feature. The presentation may be performed using at least one electronic component of the social robot 110, such as the resources 150.

According to another embodiment, when the user tries to use a certain feature incorrectly, such as by performing an incorrect sequence of actions when using the feature, the controller 130 may update the first set of data respectively. For example, the knowledge level of the user with respect to a first feature may be updated and determined to be relatively low. Therefore, and according to the same example, in certain circumstances, the controller 130 may select one of the first presentation features, customize the first presentation feature based on the first set of data which indicates the previous incorrect usage, and display the customized first presentation feature.

It should be noted that one or more of the social robot features may include more than one usage. For example, a first usage of the “read out loud” feature may include reading the user an on-line book while another usage may include reading out loud received messages on demand. Therefore, according to an embodiment, where the user is well-aware of a certain part or usage of a feature, but not of all parts of the feature, the first set of data is updated respectively by the controller 130. Then, based on the circumstances, the controller 130 is configured to select a presentation feature that is associated with the neglected part of the partially-known feature, customize the presentation feature based on the first set of data, reflecting the user's knowledge, and display the customized presentation feature.

It should be understood that the embodiments described herein are not limited to the specific architecture illustrated in FIG. 2, and that other architectures may be equally used without departing from the scope of the disclosed embodiments.

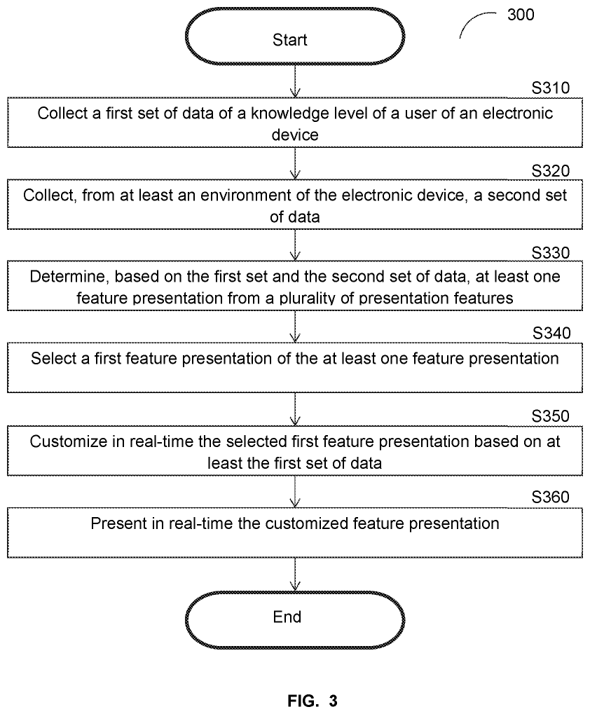

FIG. 3 is an example flowchart 300 depicting a method for real-time customization of presentation features of a social robot, according to an embodiment. In an embodiment, the method is performed by the controller 130.

At S310, a first set of data regarding a knowledge level of a user of the social robot is collected with respect to at least one feature of the social robot as further described hereinabove.

At S320, a second set of data is collected. The second set of data may include sensor data, data that collected from the internet, social media, user's calendar, other, like, sources, and any combination thereof. In an embodiment, the collection of data at S320 may be achieved using one or more sensors, such as the sensors, 140, of FIG. 1, above. The sensors may include input devices, such as various sensors, detectors, microphones, touch sensors, motion detectors, cameras, other, like, devices, and any combination thereof.

At S330, at least one presentation feature is determined from a plurality of presentation features based on the first set of data and the second set of data. In an embodiment, the determination may be achieved by applying one or more machine learning models on the second set of data and then analyzing the first set of data based the output of the one or more machine learning models. According to a further embodiment, the determination may include analyzing the first set of data and the second set of data according to at least one predetermined rule, as further discussed hereinabove.

At S340, a first presentation feature is selected from the determined at least one presentation feature. A first presentation feature may be selected at S340 by means similar or identical to those described with respect to FIG. 2, above.

At S350, the selected first presentation feature is customized in real-time, or near-real-time, based on at least the first set of data, as further described hereinabove with respect of FIG. 2.

At S360, the customized presentation feature is presented in real-time, using at least one electronic component of the social robot, such as the resources, 150, of FIG. 1, above. Customized presentation feature at S360 may include providing, as examples, and without limitation, video, audio, textual, pictorial, and other, like, forms of presentation feature or feedback, as well as any combination thereof. Further, presenting the customized presentation feature at S360 may be accomplished by means similar or identical to those described with respect to FIG. 1, above.

It should be noted that, as described herein, the term “machine learning model” may be generated using artificial intelligence (AI) methods that can provide computers with the ability to learn without being explicitly programmed. To this end, example machine learning models can be generated, trained, or programmed using methods including, but not limited to, fuzzy logic, prioritization, scoring, and pattern detection. The disclosed embodiments can be realized using supervised learning models, in which inputs are linked to outputs via a training data set, unsupervised machine learning models, where the input data set is not initially labeled, semi-supervised machine learning models, or any combination thereof.

It should be further noted that the disclosure has been presented with respect to a specific embodiment related to the interaction with a social robot. The embodiments can be equally applicable to other types of devices, such as, but not limited to, robots, service robots, smart TVs, smartphones, wearable devices, vehicles, computers, smart appliances, other, like, devices, or any combination or subset thereof.

The various disclosed embodiments may be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit.

A person skilled-in-the-art will readily note that other embodiments of the disclosure may be achieved without departing from the scope of the disclosure. All such embodiments are included herein. The scope of the disclosure should be limited solely by the claims thereto.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for real-time customization of presentation features of a social robot, comprising:
collecting a first dataset regarding a knowledge level of a user of the social robot with respect to at least one feature of the social robot;
collecting a second dataset, wherein the second dataset data is collected from at least an environment of the social robot;
determining, based on the first dataset and the second dataset, at least one presentation feature from a plurality of presentation features;
selecting a first presentation feature of the at least one presentation feature;
customizing the selected first presentation feature based on at least the first dataset; and
presenting in real-time the customized presentation feature, wherein the presentation is performed using at least one electronic component of the social robot.

2. The method of claim 1, wherein determining the at least one presentation feature further comprises:
applying a machine learning model on the second dataset; and
analyzing the first dataset with the output of the machine learning model.

3. The method of claim 1, wherein the second dataset is collected using at least one sensor.

4. The method of claim 1, wherein the at least one sensor is any one of: external to the robot and internal to the social robot.

5. The method of claim 1, wherein the presentation feature is any one of: video, audio, textual, and pictorial.

6. The method of claim 1, wherein the knowledge level is indicative of a skill level of the user with the presentation features.

7. The method of claim 1, further comprising:
iteratively customizing each of the least one presentation feature.

8. A non-transitory computer readable medium having stored thereon instructions for causing a processing circuitry to execute a process, the process comprising:
collecting a first dataset regarding a knowledge level of a user of the social robot with respect to at least one feature of the social robot;
collecting a second dataset, wherein the second dataset data is collected from at least an environment of the social robot;
determining, based on the first dataset and the second dataset, at least one presentation feature from a plurality of presentation features;
selecting a first presentation feature of the at least one presentation feature;
customizing the selected first presentation feature based on at least the first dataset; and
presenting in real-time the customized presentation feature, wherein the presentation is performed using at least one electronic component of the social robot.

9. A controller for real-time customization of presentation features of a social robot, comprising:
a processing circuitry; and
a memory, the memory containing instructions that, when executed by the processing circuitry, configure the controller to:
collect a first dataset regarding a knowledge level of a user of the social robot with respect to at least one feature of the social robot;
collect a second dataset, wherein the second dataset data is collected from at least an environment of the social robot;
determine, based on the first dataset and the second dataset, at least one presentation feature from a plurality of presentation features;
select a first presentation feature of the at least one presentation feature;
customize the selected first presentation feature based on at least the first dataset; and
present in real-time the customized presentation feature, wherein the presentation is performed using at least one electronic component of the social robot.

10. The controller of claim 9, wherein the controller is further configured to:
apply a machine learning model on the second dataset; and
analyze the first dataset with the output of the machine learning model.

11. The controller of claim 9, wherein the second dataset is collected using at least one sensor.

12. The controller of claim 9, wherein the at least one sensor is any one of: external to the robot and internal to the robot.

13. The controller of claim 9, wherein the presentation feature is any one of: video, audio, textual, and pictorial.

14. The controller of claim 9, wherein the knowledge level is indicative of a skill level of the user with the presentation features.

15. The controller of claim 9, wherein the controller is further configured to:
iteratively customize each of the least one presentation feature.
